(19) United States
(12) Patent Application Publication
(10) Pub. No.: US 2023/0219274 A1
(43) Pub. Date: Jul. 13, 2023

(54) METHODS AND SYSTEMS FOR MEASUREMENT AND CONTROL OF CIRCUMFERENTIAL LAYER DISTRIBUTION IN BLOWN FILMS

(71) Applicant: 3M INNOVATIVE PROPERTIES COMPANY, St. Paul, MN (US)

(72) Inventors: William W. Merrill, Mahtomedi, MN (US); Pradeep P. Bhat, Cottage Grove, MN (US); Francis T. Caruso, Hudson, WI (US); David L. Hofeldt, Oakdale, MN (US); David D. Nguyen, Savage, MN (US); Ziang Li, Newark, DE (US)

(21) Appl. No.: 17/999,977

(22) PCT Filed: Jun. 9, 2021
(86) PCT No.: PCT/IB2021/055079

§ 371 Date: Nov. 28, 2022

Related U.S. Application Data
(60) Provisional application No. 63/041,446, filed on Jun. 19, 2020.

(51) Int. Cl. B29C 48/92; B29C 48/32; B29C 48/00; B29C 48/18; G01B 11/06; G01B 11/24

(52) U.S. Cl. CPC B29C 48/92; B29C 48/32; B29C 48/0018; B29C 48/18; G01B 11/06; G01B 11/24; B29C 2948/92152; B29C 2948/92704; B29C 2948/92904

(57) ABSTRACT

A sensing system for measurement of a multilayered blown polymeric film. A feedblock supplies polymeric material streams to an annular blown film die to form a plurality of layers of different polymeric materials. A sensing system is positioned adjacent to a film bubble extruded from the blown film die, wherein the blown film bubble includes annular layers of at least two different polymeric materials. The sensing system emits a signal toward selected circumferential positions around the film bubble and receives a plurality of reflected signals at each circumferential position. Each reflected signal in the plurality of reflected signals is generated at an interface between annular layers that includes a refractive index change detectable by the sensing system. A processor processes the reflected signals from the sensing system, and for each circumferential position determines a layer thickness profile for each polymeric material in the film.

### BACKGROUND

Blown film is an important process for making multi-layer films including materials with sometimes very different rheological (flow) characteristics such as viscosity and elasticity. In general, products made from such blown films are made by dividing the total blown bubble into a series of final product rolls cut from various lanes of the bubble. Thus, the individual rolls come from various circumferential positions around the blown bubble. Despite the fact that these circumferential positions may vary along any given roll as it is being wound, e.g. due to winding oscillations to improve roll formation when total caliper is variable around the roll, at any instant, each converted roll material point can be mapped to a particular location range around the circumference of an exit of an annular extrusion die used to make the film.

Each multi-layer blown film includes different layers made from melt streams of different materials, so the actual product performance will in some cases be impacted by the layer thickness profile of the various layers, in addition to the absolute total thickness of the construction.

Layer uniformity has been controlled in multi-layer films such as multi-layer optical films, in which the layers themselves literally reflect the layer shape distribution of the multi-layer optical construction through a measurable transmission or reflection optical response (spectrum). In optical films the actual optical thickness of each layer is the over-riding interest as this controls the actual wavelengths reflected or transmitted by the film construction.

### SUMMARY

Typically, in multi-layer optical films, the polymeric material streams are divided into numerous separate layers by the multiple channel (feeder tubes) inside the feedblock. Thus, the number of final layers is typically much greater than the initial number of polymeric material streams represented, e.g. by the number of separate extruders used. In contrast, with the blown films considered in the present disclosure, the polymeric material streams are divided by feeder tubes and channels to different circumferential positions of the same layer. In some cases, these feeder tubes and channels can be further separated into multiple separate layers. However, the individual polymeric material streams fed by the individual extruders remain a single layer added inside the annular final channel of the die. Moreover, as the various polymeric material streams enter the annular final channel of the die, a newly introduced stream, if sufficiently similar, may merge with the proximately introduced previous material stream. Sufficiently similar may include polymeric material streams of the same material, or polymeric material streams of sufficient similar refractive index (e.g. in the terahertz range) to appear as a single layer when measured. Thus, the typical blown film construction results in a number of final layers equal to or less than the number of polymeric material streams individually fed into the annular die. In the latter case of similar refractive indices, the number of measured layers including polymeric material is still less than the number of actual functional layers.

A consistent material construction around the bubble circumference is ultimately essential to the highest product quality with consistent product performance among the various rolls or piece-parts cut from a single bubble. However, blown films do not provide a direct visual signature like optical films, which provide a direct indication of the absolute optical thicknesses of the various layers, and other spectral means are needed. The apparatus and methods of the present disclosure control the shape of the layer profile, a relative indication of layer thickness, as a quantity of principal interest. By controlling the shape of the layer profile, the apparatus and methods of the present disclosure can provide a more uniform blown film multi-layer material construction circumferentially around the bubble.

A consistent material construction around the bubble circumference can be important to providing the highest product quality with consistent product performance among the various rolls or piece-parts cut from a single bubble.

The methods of the present disclosure provide an apparatus and method for making more circumferentially uniform blown film multi-layer material constructions. Examples of products having such constructions include tapes, liners and other tape-related products, films, e.g. for industrial and consumer use such as packaging, barrier, insulation, protective and decorative applications, medical and other therapeutic wraps, coverings, and the like. Although these products are major sub-classes of products that could potentially be improved using the techniques of the present disclosure, improved uniformity impacts all products using a multi-layer, multi-material and thus multi-functional construction made with a blown film process.

In some cases, the methods and apparatus of the present disclosure may provide a significant cost-down pathway for manufacturing. For example, in some product applications, certain functional layers may require a certain minimum thickness. If such a product must increase the overall thickness of a given material layer to ensure the meeting of such an absolute thickness requirement, the methods and apparatus of the present disclosure can reduce costs, especially if these materials are expensive. The measurement techniques and apparatus of the present disclosure can provide a method of ensuring that a critical product metric is met. Control ensures the lowest amount of material usage to achieve this metric providing the cost-down pathway.

In one aspect, the present disclosure is directed to a sensing system for measurement of a multilayered blown polymeric film. The sensing system includes: a feedblock configured to supply a plurality of polymeric material streams to an annular blown film die to form a plurality of layers including different polymeric materials; a sensing system positioned adjacent to a film bubble extruded from the blown film die, wherein the blown film bubble includes annular layers of at least two different polymeric materials, wherein the sensing system emits a signal toward selected circumferential positions around the film bubble and receives a plurality of reflected signals at each circumferential position, wherein each reflected signal in the plurality of reflected signals is generated at an interface between annular layers, and wherein the interface includes a refractive index change detectable by the sensing system; and a processor that processes the reflected signals from the sensing system, wherein the processor is configured to, for each circumferential position: determine a layer thickness profile for each polymeric material in the multilayer polymeric film for which layer thickness data are obtained; and determine, based on the layer thickness profile and an average layer thickness profile around the circumference of the multilayer polymeric film bubble, a layer shape distribution for the polymeric material in each layer of the multilayer polymeric film.

In another aspect, the present disclosure is directed a blown film line, including: a feedblock configured to supply at least two different polymeric material streams to an annular blown film die to form a plurality of at least two layers comprising different polymeric materials; at least one terahertz (THz) sensor that emits a THz signal toward selected circumferential positions around the film bubble and receives a plurality of reflected signals at each circumferential position, wherein each reflected signal in the plurality of reflected signals is generated at an interface between annular layers of the at least two different polymeric materials in the multilayered polymeric film bubble, wherein the interface comprises a change in refractive index detectable by the THz sensor, and wherein the annular layers have a thickness of greater than about 25 microns; and a film line controller that receives the plurality of reflected signals from the THz sensor, wherein the film line controller includes a processor configured to, for each circumferential position: determine a layer thickness profile for each polymeric material in the multilayer polymeric film bubble for which layer thickness data are obtained; and determine, based on the layer thickness profile and an average layer thickness profile around the circumference of the multilayer polymeric film bubble, a layer thickness distribution of the polymeric material in each layer of the multilayer polymeric film bubble; and wherein the film line controller provides control signals based on the layer thickness distribution to at least one layer control mechanism within the feedblock to maintain a layer shape metric based on the layer thickness distribution for the multilayer polymeric film bubble.

In another aspect, the present disclosure is directed to a method for online measurement of a blown multilayer polymeric film, the method including: positioning a terahertz (THz) sensor adjacent to a multilayer polymeric film bubble extruded from an annular blown film die, wherein the multilayer polymeric film bubble includes a plurality of annular layers of at least two different polymeric materials, wherein at least two of the different polymeric materials have differing refractive indices, and wherein at least two of the annular layers comprising different polymeric materials have a thickness of greater than about 10 microns; guiding the THz sensor around a circumference of the film bubble; emitting a THz signal from the THz sensor toward selected circumferential positions around the film bubble, wherein the THz sensor receives a plurality of reflected signals at each circumferential position, and wherein each reflected signal in the plurality of reflected signals is generated at an interface between the annular layers of the polymeric material in the multilayered polymeric film bubble, wherein the interface comprises a refractive index change detectable at a THz frequency; and providing the reflected signals from THz sensor to a processor configured to, for each circumferential position around the film bubble: determine a layer thickness profile for each measurable layer in the multilayer polymeric film bubble for which a layer thickness is obtained; and determine, based on the layer thickness profile and an average layer thickness profile around the circumference of the multilayer polymeric film bubble, a layer thickness distribution of the polymeric material in each annular layer of the multilayer polymeric film bubble; and generating a control signal based on the layer thickness distribution to control at least one layer control system within a feedblock supplying polymeric materials to the blown film die, wherein the layer control system maintains a predetermined layer shape profile of the multilayer polymeric film bubble.

In another aspect, the present disclosure is directed to a sensing system for online measurement of a multilayered blown polymeric film comprising a plurality of polymeric materials, wherein at least two of the polymeric materials have differing refractive indices at a terahertz (THz) frequency, the sensing system including: a terahertz (THz) sensor positioned adjacent to a film bubble extruded from an annular blown film die, wherein the blown film bubble includes annular layers of at least two polymeric materials, wherein the annular layers have a thickness of greater than about 25 microns; a sensor support configured to guide the THz sensor around the circumference of the film bubble, wherein the THz sensor emits a THz signal toward selected circumferential positions around the film bubble and receives a plurality of reflected signals at each circumferential position, wherein each reflected signal in the plurality of reflected signals is generated at an interface between the annular layers of polymeric materials in the multilayered polymeric film, the interface comprising a refractive index change detectable at a THz frequency; and a processor that processes the reflected signals from the THz sensor, wherein the processor is configured to generate a layer thickness distribution at each circumferential position of the polymeric material in each annular layer of the multilayer polymeric film.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1A is a schematic diagram of an example embodiment of a blown film manufacturing line.

FIG. 1B is a top view the blown film manufacturing line of FIG. 1A.

FIG. 2A is a schematic block diagram of an embodiment of a THz sensor.

FIG. 2B is a schematic diagram of a portion of a film bubble being detected by the THz sensor of FIG. 2A.

FIG. 3 is a flow chart of an embodiment of a method for determining a layer thickness fraction according to the present disclosure, and using the calculated layer thickness fraction to generate a control signal to operate at least one layer control mechanism in blown film process line.

FIGS. 4A-4D are a collection of plots illustrating an embodiment of determining a layer thickness fraction according to Example 1.

FIG. 5 is schematic diagram of the die/feedblock plate that creates Layer 7 in the equipment used in Example 4. The polymeric resin is fed from the west side. Segmented band heaters, Heaters A-D, wrap around the plate (shaded part) in the manner shown. The crossweb locations of the lay-flat film produced is also shown in the schematic using a red colored curve. Location 0/1 coincides with the east side of the bubble; 0.25, with the south side; 0.5, with the west side; and 0.75, with the north side.

FIG. 6 is a plot showing circumferential variation of the normalized layer-thickness-fraction (see text for details) for Layer 7 between Conditions 1 and 2 in Example 4. The blue curve corresponds to the roll made during Condition 1 and the orange curve corresponds to Condition 2. The arrows are included to highlight the local increase or decrease in the layer thickness in regions that respond to the actions of the heaters (see FIG. 5 for their locations).

FIG. 7 is a schematic diagram of the apparatus of Example 4 showing the approximate locations of the feeding channels to the spiral within the flat-spiral layer plate with respect to the locations of the segmented band heaters that wrap around the plate.

Like symbols in the drawings indicate like elements.

### DETAILED DESCRIPTION

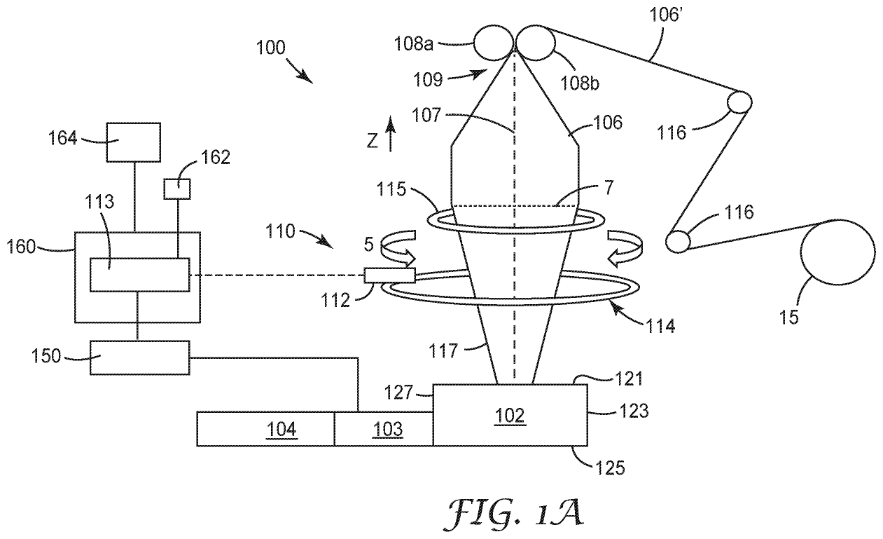

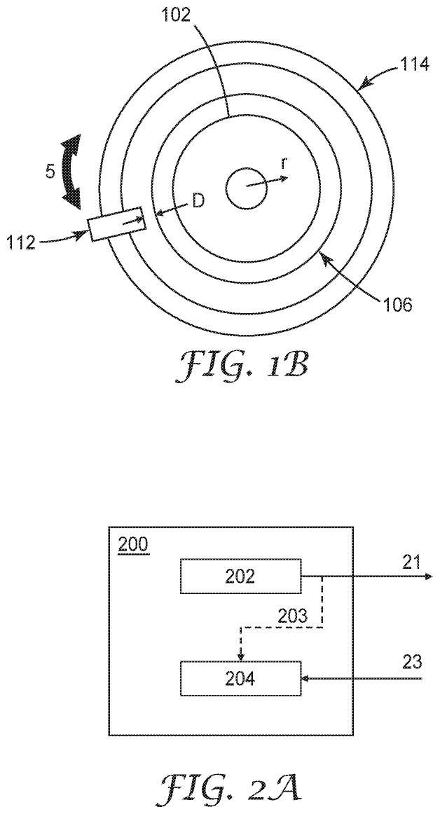

FIG. 1A is a schematic diagram of an example embodiment of a blown-film manufacturing system or line 100, while FIG. 1B is a top view of the system 100 of FIG. 1A. The system 100 includes an annular blown film die 102 coupled with associated extruders 104. Each extruder 104 compacts and melts various polymeric materials and the polymeric material stream is then supplied to the die 102. Each polymer material can be compacted and melted to form a continuous, viscous liquid stream, which is then supplied under pressure to a region of the die 102. In the present application the term feedblock refers to a portion 125 of the die 102 in which the melt train of the materials of the various polymeric melt streams are distributed circumferentially, and joined together, e.g. to form a multi-layer annular flow. The die 102 may refer to either or both the region 125, and also to a final region 127 of the polymeric material flow channel after all polymeric material streams have joined in a combined melt stream.

In this final region 127, the combined melt stream includes layers formed from the individual polymeric material streams. Although each polymeric material stream has been added individually to the combined melt stream, if the polymeric materials of adjacently added streams are insufficiently different, the number of measurable layers will be less than the number of initial polymeric material streams. For example, two adjacently added polymeric material streams of substantially the same material will combine to form a single layer. In a different example, two adjacently added polymeric material streams of substantially the same refractive index (e.g. in the terahertz range) will combine to form a single measurable layer, even though two functional layers may exist. In another example, if two adjacently added polymeric material streams are sufficiently thin (e.g. optically thin in the terahertz range) will combine to form a single measurable layer, even though two functional layers may exist. In all these cases, the polymeric materials of the measurable layers include the polymeric materials of the streams forming that measurable layer.

Streams of polymeric materials emerging from the extruders 104 encounter one or more layer control mechanisms 103, which can be used individually or in combination to control the flow rate of a particular polymeric material into the die 102, which can assist in the control of the amount of polymeric material supplied into each region around a circumference of the annular die 102. For example, the layer control mechanism 103 may be utilized to supply a first polymeric material to a first region of the annular die 102, to supply a second polymeric material different from the first polymeric material to a second region of the die 102, to supply a third polymeric material to a third region of the die 102, and the like.

In addition, the layer control mechanism 103 can be utilized to adjust the flow rate of a polymeric material to a selected region of the annular die 102. For example, in one embodiment, the layer control mechanism 103 can include at least one heating zone to adjust the viscosity and corresponding flow rate of the polymeric material provided from the extruder 104. For example, the heating zones can control a temperature of a feeder tube that supplies a region around the circumference of the die 102. In some embodiments of a layer control mechanism, the circumferential flow distribution is achieved by external zone heaters that alter the temperature of feeder tubes around the annular flow circumference. These external heaters can establish circumferential temperature distribution with variation of 5, 10, 15, 25 or more ° C. Such zonal heating can alter the distribution of flow circumferentially, e.g. by changing the viscosity of the layer material circumferentially, which in turn changes the flow rate around the circumference, e.g. for a given pressure drop from the entrance feedline to the feedblock 125 to the point where the particular layer joins into the annular flow cavity.

In another embodiment, the layer control mechanism 103 can include one or more heaters, which can be located in the die 102. In some examples, the heaters can be embedded inside the feedblock 125. For example, heaters can be strategically placed along feeder tubes for the polymeric material, around a mixing flow manifold prior to layer joining, or even inside the annular flow channel, e.g. inside a central stem of the die 102. In other embodiments, combinations of these heaters may be used.

In another embodiment, the layer control mechanism 103 includes a flow resistance control device including, but not limited to, a valve or a vane that controls the supply of a particular polymer to a certain region of the die 102, bolts in the die that can be manually adjusted to control flow rate in various passages or regions of the die, and the like. For example, valves or vanes can be used to control the flow in the feeder tubes that distribute the material circumferentially towards the annular flow cavity. In other embodiments, internal structures can otherwise alter the relative thickness of the flow channels in the feedblock 125 or the die 102. For example, the central stem of the die 102 can be offset or tilted as a function flow direction as the various layers join in the annular flow cavity. Again, these various layer flow control mechanisms can be combined and can also be used together with the zonal temperature layer flow control mechanisms described above.

In some cases, adjustments in the final flow cavity made by the layer control mechanisms 103 can create pressure and shear rate differences circumferentially that can create circumferential flows of some of the material layers altering the layer shape of one or more of the material layers. For example, adjustment of the die bolts that alter the concentricity of the inner and outer die radii may be used as an active control method. Back pressure effects from other changes in the die 102, such as die lip heaters, may also have an impact. In other cases, some or none of these adjustments may have a significant impact on the circumferential layer shapes, but may nevertheless impact the total thickness profile of the film around the circumference.

The polymeric materials exit the die 102 at a die exit 121 to extrude a film bubble or a film tube 106, which moves in the direction of an arrow Z along an approximate axis of bubble conveyance 107. In some embodiments, a fluid such as air can be injected through a hole in the center of the die 102, and the pressure causes the extruded melt to expand into the bubble 106.

Blown film extrusion processes can be carried out vertically upwards, horizontally, or downwards. In some embodiments, the bubble 106 can be pulled continually from the die 102 and an optional cooling ring 115 can be provided, e.g. to blow air onto the film. In another embodiment, the bubble 106 can also be cooled from the inside using internal bubble cooling, e.g. with a separate air cooling supply and return system. In other cases, e.g. when the bubble is carried out vertically downwards, the cooling ring can be provided by a cold water bath.

The system 100 further includes a sensor system 110, 110 including a sensor 112 positioned adjacent to the film bubble 106. The sensor system 110 in further described in FIG. 1B. In the embodiment of FIG. 1A, the sensor system 110 is between the die 102 and the cooling ring 115. However, in various embodiments the sensor system 110 may be located in any position downstream of the die 102 and upstream of the nip rollers 108a and 108b, or in some cases may be placed downstream of the lay-flat section 109.

After solidification at a frost line 7, the film can move into the set of nip rollers 108a-b, which collapse the bubble 106, which is then flattened into a doubled film 106′. This flattened, doubled film is also known as the “layflat” film. The doubled film 106′ may be transferred, e.g., via optional idler rolls 116, and wound into a roll by a roll winder 15. Typically, the doubled film 106′ is slit into two or more separate films, e.g. at least along the folded edges of the (layflat) doubled film, and then each slit film is separately wound. Optionally, additional processes may be applied to the film either before or after the nip rollers 108. For example, prior to the nip rollers, various mechanisms such as adjustable roller cages can assist in the laying flat of the bubble. Additional heating and cooling schemes may also be applied, for example using an active array of circumferentially zoned air heaters. After the nip rollers, additional temperature (heating/cooling) and stretching processes may be applied either before or after slitting. Additional material layers may also be applied, e.g. with any variety of coating means.

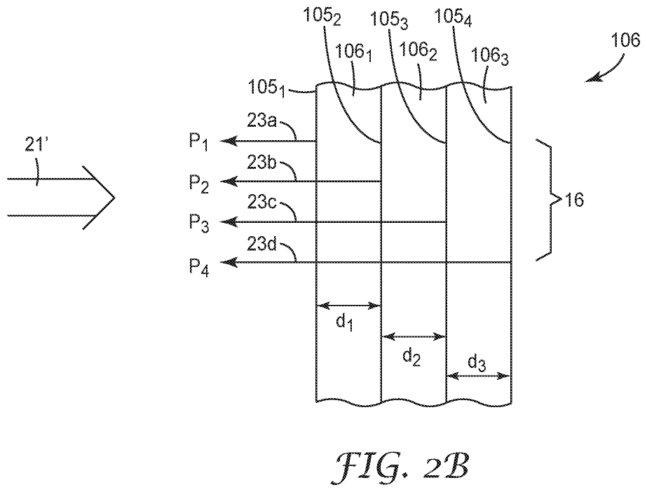

Referring now to FIG. 1B, the sensor 112 of the sensor system 110 is positioned adjacent the film bubble 106 with a standoff distance D. The sensor 112 can include, for example, a terahertz (THz) sensor configured to emit a THz radiation/beam toward the film bubble 106, and detect signals reflected from the film bubble 106. A block diagram of an exemplary THz sensor is shown FIG. 2A, which will be described further below.

In some embodiments, the sensor 112 may be configured to scan circumferentially around the bubble along a path, for example, as defined by a sensor support 114, at some prescribed speed along the path. In some embodiments, it is advantageous to locate the sensor support system 114 near the die exit 121, where the layers are thicker, which can enhance sensor measurement resolution. In one particular embodiment, the sensor 112 is supported so that the sensor measures the bubble layers as the bubble 106 stretches between the die exit 121 and the cooling ring 115. When the resolution of the sensor 112 is sufficient, in various embodiments, the sensor and support may be located elsewhere, e.g. above the cooling ring 115, or even after the freezeline 7. In some cases, the sensor system 110 may include a plurality of sensors 112 for enhanced time and spatial resolution. The plurality of sensors may scan around circumferentially in a correlated manner in some configurations. In other configurations, the plurality of sensors may be placed at fixed circumferential positions. In still other example configurations, combinations of scanning and fixed sensors may be used.

In some embodiments, the sensor system 110 may further include a processor 113 in a computing device 160 to process the detected signals from the sensor 112 to determine, for example, one or more physical properties of the film bubble 106. In various embodiments, the processor 113 may be integrated with the sensor system 110, or may be a remote processor. In some embodiments, the processor 113 is functionally connected to a controller 150 or layer control mechanism 103 for the blown-film system 100, or may be integrated with the layer control mechanism 103.

The processor 113 in the computing device 160 may be any suitable software, firmware, hardware, or combination thereof. The processor 113 may include any one or more microprocessors, controllers, digital signal processors (DSPs), application specific integrated circuits (ASICs), field-programmable gate arrays (FPGAs), or discrete logic circuitry. The functions attributed to the processor 113 may be provided by processing circuitry of a hardware device, e.g., as supported by software and/or firmware.

In some examples, the processor 113 may be coupled to memory 162, which may be part of the computing device 160 or remote thereto. The memory 162 may include any volatile or non-volatile media, such as a random-access memory (RAM), read only memory (ROM), non-volatile RAM (NVRAM), electrically erasable programmable ROM (EEPROM), flash memory, and the like. The memory 162 may be a storage device or other non-transitory medium. The memory 162 may be used by the processor 113 to, for example, store fiducial information or initialization information corresponding to, for example, measurements of layer thickness distributions, layer distribution functions, and the like. In some examples, the processor 113 may store layer thickness distribution information or previously received data from electrical signals in memory 162 for later retrieval. In some examples, the processor 113 may store determined values, such as information corresponding to detected layer thickness measurements and layer thickness distribution calculations, and the like, in memory 162 for later retrieval.

In some embodiments, the processor 113 is coupled to user interface 164, which may include a display, user input, and output (not shown in FIG. 1A). Suitable display devices include, for example, monitor, PDA, mobile phone, tablet computers, and the like. In some examples, user input may include components for interaction with a user, such as a keypad and a display such as a cathode ray tube (CRT) display, a liquid crystal display (LCD) or light emitting diode (LED) display, and the keypad may take the form of an alphanumeric keypad or a reduced set of keys associated with particular functions. In some examples, the displays may include a touch screen display, and a user may interact with user input via the touch screens of the displays. In some examples, the user may also interact with the user input remotely via a networked computing device.

The film line controller 150 is configured to control any selected number of functions of the film line 100 including, the extruders 104, the layer control mechanisms 103, and the die 102. For example, the film line controller can adjust the control of the amount of polymeric material supplied into each region around a circumference of the annular die 102. The film line controller 150 may adjust any or all of the heaters, vanes or valves in the extruder 104 or the die 102 in response to signals from the processor 113 or input manually into the computing device 160, or stored in the memory 162.

In some embodiments, the film line controller 150 can generate control signals, based in part on layer thickness information from the sensor 112, to provide closed loop control of the width and thickness of the foil 117 extruded from the die 102. In some embodiments, the sensor 110 can be combined with other types of sensors or measuring devices to measure the properties of the film bubble 106, or other operation parameters in a blown-film extrusion process performed by the process line 100. The properties or operation parameters may include, for example, a viscosity of the extruded material, an air pressure inside the film bubble 106, a temperature of cooling air blown against the film bubble 106, a temperature of the polymer melt in the die 102, and the like.

The film line controller 150 may be adjusted by a variety of manual and automatic means. Automatic means may make use of any number of control algorithms or other strategies to achieve the desired conformance to the control parameter or desired circumferential function, e.g. a layer shape distribution uniformity metric. For example, standard PID control schemes as well as adaptive algorithms such as so-called “machine-learning” algorithms may be used. In some embodiments, the film line controller 150 can utilize information from other sources such as, for example, infrared cameras, to determine the control action decided by algorithms such as PID control schemes or machine learning schemes.

In the depicted embodiment of FIGS. 1A-B, the sensor support 114 includes a scanner track around the circumference of the film bubble 106 to support and guide the sensor 112. The sensor support 114 is configured to position the sensor 112 at a safe distance (e.g., a standoff distance D) away from the film bubble 106. In the depicted embodiment of FIGS. 1A-B, the sensor support 114 can continuously move the sensor 112 around the film bubble 106 in the circumferential direction 5, while the sensor 112 measures the characteristics of the film bubble 106. The sensor support 114 can guide the sensor 112 to move around the circumference of the film bubble 106 in any suitable manner, e.g., an oscillating movement as indicated by the arrow 5, a centripetal movement, an axial movement along the direction of the arrow Z, a radial movement along the radial direction r, and the like, as needed to obtain optimal measurements and control functions.

In some embodiments (not shown in FIG. 1B), the sensor support 114 includes an angularly adjustable mount such that the sensor 112 emits a beam, which in some embodiments is a THz beam, directed toward a sensing point on the film bubble at a substantially normal incidence. In some embodiments, the angular adjustment may be manually set. In other embodiments, the angular adjustment may be automatic. Typically, the sensor may be directed to the sensing point along a line that intersects approximately with the approximate average axis of bubble conveyance 107. This line and axis thus define an immediate sensing plane. The adjustment angle may then refer to the direction of this sensing line in the sensing plane relative to the plane normal to the bubble axis. Angular adjustment, e.g. to achieve substantially normal incidence, may be assisted by optional visualization systems that provide geometrical details of the bubble. For example, a visible or infra-red camera system can be focused normal to the sensing plane at the sensing point to estimate the plane normal of the bubble at this sensing point. Such a camera system could be stationary or mobile (e.g. jointly mounted on sensor support 114) to adaptively determine the instantaneous angle of the sensor at various measured circumferential positions and times.

The standoff distance D between the sensor 112 and the film bubble 106 may vary depending on, for example, the focal length of the sensing beam selected for the sensor 112, fluctuations of the film bubble 106 along the radial direction r during operation, and the like. In general, the sensor 112 can be located at a safe distance D away from the film bubble 106 such that an incidental contact therebetween during a blown-film process can be avoided.

Exemplary ranges of the standoff distance D, which are not intended to be limiting, can be from about 5 mm to about 500 mm. In some embodiments, when the sensor 112 employs a sensing beam that is focused over a 25 mm focal length, typical ranges of the standoff distance D may be, for example, from about 10 to about 40 mm. In some embodiments, when a sensing beam employing a 75 mm focal length is used, typical ranges of the standoff distance D may be, for example, from about 60 to about 90 mm. In some embodiments, when a sensing beam employing a 10 or 150 mm focal length is used, typical ranges of the standoff distance D may be, for example, from about 135 to about 165 mm.

In various embodiments, the film bubble 106 may have a diameter along the radial direction r that fluctuates during a blown film extrusion process. Such an operating fluctuation of the bubble walls of the film bubble 106 along the radial direction r can be in the range, for example, about ±5 mm. In some embodiments, suitable bubble tracking procedures can be provided to detect the fluctuations and determine and maintain the desired standoff distance D between the bubble film and the sensor. In some embodiments, the desired standoff distance can be maintained by mounting the sensor onto a linear, motorized stage that can traverse the sensor normal to the surface of the material. In some embodiments, a distance measurement sensor can be used to determine a distance between the sensor and the film bubble and use this reading to instruct the motorized stage to move the layer thickness sensor 112 to maintain a nominal distance D from the bubble.

The sensor 112 may utilize a wide variety of optical techniques to measure the layer thicknesses of the film bubble 106, as long as the materials layers in the film bubble 106 are sufficiently optically transmissive to allow a reflected signal to return to the sensor. For example, suitable optical techniques include, but are not limited to, triangulation, optical coherence tomography, interferometry and holography. However, terahertz (THz) sensors have been found to be particularly useful to measure a wide variety of materials of interest to blown film operations, including foams and loaded materials, as these materials are suitably transparent to THz wavelengths, while transmissivity through these materials may be more difficult using other optical techniques.

In some embodiments, the sensor 112 is a THz sensor that includes emitting and receiving elements that respond to electromagnetic waves in the frequency range extending nominally from 0.01 THz to 10 THz. There are both continuous wave and pulsed versions of such systems that can be used for studies of material properties such as, for example, composition, density, and/or thickness. In some embodiments described herein, sensing data are obtained with a pulsed time-domain system. It is to be understood that those skilled in the art can recognize that similar information can be obtained from frequency-domain THz systems or other suitable types of THz sensors. Exemplary THz sensors or systems are described in U.S. Pat. Nos. 9,316,582; 9,104,912; 10,267,836; and 10,215,696; which are incorporated herein by reference.

FIG. 2A is a schematic block diagram of an embodiment of an exemplary THz sensor 200 that may be utilized in the system 100 of FIGS. 1A-1B. The THz sensor 200 includes a THz pulse generator 202 to generate THz pulses from an optical pulse system thereof and emit the generated THz pulses 21 toward a targeted material to be measured. In some embodiments, the optical pulse from the optical pulse system can be split to provide an optional probe pulse 203, which can strobe the THz pulse detector 204 when the detector 204 receives the THz pulses reflected from the targeted material. The detector 204 can detect the reflected THz pulses 23 and generate a signal as a function of time, which can then be transmitted to either or both of the processor 113 and the controller 150 (FIG. 1A). One example of a suitable THz sensor, which is not intended to be limiting, is commercially available from Luna Inc. (Roanoke, Va.) under the trade designation Terametrix T-Gauge TCU5220.

FIG. 2B is a schematic diagram of an example embodiment of a portion of a multilayered polymeric film bubble 106 being detected by a THz sensor. The multilayered film bubble includes a first layer 106₁ of a first polymeric material having a first refractive index, a second layer 106₂ of a second polymeric material having a second refractive index different from the first refractive index, and a third layer 106₃ of a third polymeric material having a third refractive index different from the first and the second refractive indices.

A THz beam 21′ is directed toward the film bubble 106. A typical THz beam may have a THz frequency in the range, for example, from about 0.01 to about 10 THz. The THz beam 21′ can readily propagate through various polymer material systems including, for example, continuous materials, multi-component materials, filled materials, foamed materials, and the like.

The THz beam 21′ can be focused to have a spot size covering a targeted area 16 of the film bubble 106. The spot size of the THz beam 21′ can be controlled to obtain an effective spatial resolution much higher compared to other types of sensors such as capacitive sensors and gamma backscatter sensors. In some embodiments, the spot size of the THz beam 21′ can be controlled on the order of about 1 mm in diameter or about 1 mm² in area. In some embodiments, the spot size of the THz beam 21′ can be in the range, for example, from about 0.001 mm² to about 1000 mm², from about 0.01 mm² to about 500 mm², from about 0.01 mm² to about 200 mm², or from about 0.01 mm² to about 100 mm². In some embodiments, the spot size of the THz beam 21′ may be no greater than about 1000 mm², no greater than about 500 mm², no greater than about 200 mm², no greater than about 100 mm², no greater than about 50 mm², or no greater than about 10 mm².

When the THz beam 21′ is reflected by the outer surface 105₁ (an air/film interface) of the film bubble 106, a signal P1 can be generated by a THz sensor by detecting the reflected pulse 23a. When the THz beam 21′ is reflected by the interface 105₂ between the first layer of the first polymeric material 106₁ and the second layer of the second polymeric material 106₂, a signal P2 can be generated by a THz sensor by detecting the reflected pulse 23b. When the THz beam 21′ is reflected by the interface 105₃ between the second layer of the second polymeric material 106₂ and the third layer of the third polymeric material 106₃, a signal P3 can be generated by a THz sensor by detecting the reflected pulse 23c. When the THz beam 21′ is reflected by the interface 105₄ (a film/air interface) of the film bubble 106, a signal P4 can be generated by a THz sensor by detecting the reflected pulse 23d. While the schematic description in FIG. 2B shows that all interfaces between layers having differing refractive indices in a film bubble create a reflected pulse detectable by the THz sensor, in some cases not all interfaces may create a detectable reflected pulse.

The reflected signals can be detected and processed by either or both of the processor 113 and the system controller 150 to determine values proportional to the respective thicknesses d₁ of the first layer of the first polymeric material 106₁, the thickness d₂ of the second layer of the second polymeric material 106₂, and the thickness d₃ of the third layer of the third polymeric material 106₃ within the targeted area 16 of the film bubble 106.

The layer shape profile of a blown film as determined according to the present disclosure is a quantity that characterizes the relative physical amount of polymeric material in each layer (for example, layers 106₁, 106₂, 106₃ of FIG. 2B). One example of a layer shape profile is a measure of a relative thickness of a layer around the circumference of the bubble, e.g. as provided by a sensor system 110. This thickness may be a relative optical thickness, a relative physical thickness or some other derived relative thickness, e.g. a thickness as derived from a capacitance measurement. In other examples, the layer shape profile is a measure of relative thickness that minimizes the effects of control measures or process upsets that alter the total physical caliper around the circumference of the bubble 106 at or downstream of the die exit 121. In a further example, the layer shape profile may also minimize the effects of control measures or process upsets that alter the pumping and thus total flow amounts of a polymeric material of a given material layer upstream of the die 102, or in the feed lines from the extruder 104 supplying polymeric materials into the die 102.

In the present application, a particularly useful layer shape profile, the layer shape distribution of the blown film 106, is defined as the layer thickness fraction divided by the average layer thickness fraction of that particular layer around the bubble. The layer thickness fraction at any circumferential position is the layer thickness divided by the total film thickness in the same spot of the film bubble 106. The layer thickness fraction is a measure of the amount of layer material around the bubble 106 that is generally fixed by the flow field inside the extruder 104 and the die 102.

Thus, the layer fraction function around the circumference of the bubble 106 is relatively insensitive to downstream processing including die lip total caliper adjustment (via physical bolt or heating methods), stretching and variation in heating and cooling of the bubble in the blowing melt curtain. Dividing the layer fraction by the average layer fraction to obtain the layer shape distribution around the bubble normalizes the layer fraction to a shape function that varies around the absolute value of unity, and it makes the control function independent of the thickness proportionality constant of the sensor.

Particular layers can increase in total layer fraction due to deliberate rate changes or upsets and fluctuations (e.g. pressure surging) affecting the amounts of polymeric materials delivered to the die 102 by the extruder 104. Dividing by the instantaneous average layer fraction around the bubble 106 thus eliminates these layer material pumping rates changes (e.g. upstream fluctuations). Clearly, the closer this circumferential layer shape distribution converges to unity around the circumference, the more uniformly the material comprising the layer is distributed around the bubble 106.

Any number of uniformity metrics can be used to quantify the uniformity of the layer shape distribution. For example, the maximum percent (%) variation around the circumference may be used, or the standard deviation around the circumference may be used. The film line controller 150 can adjust the layer control mechanism 103 according to a chosen algorithm to achieve a minimum of the uniformity metric within a specified tolerance. Typically, the algorithm would consider the circumferential position of the data from the sensor 112 and the corresponding circumferential effects from the layer control mechanism 103 in order to make such adjustments.

A layer shape distribution can be obtained using any method that measures thickness of the layers or the relative thicknesses between the layers in a multilayer, and the total thickness or relative total thickness of the film 106. The thickness can be defined according to any suitable metric. For example, the physical thickness of the layer can be measured, e.g. in microns, or the optical thickness of the layer can be measured, for example, using an interference pattern which is then translated into an optical thickness. This optical thickness can then be converted to a physical thickness, e.g. by dividing the optical thickness by prescribed refractive index for the layer.

A variety of methods can be used to measure the layer thicknesses. In some cases, the films can be destructively tested by peeling apart the layers and measuring them individually, e.g. using a physical drop caliper gauge (e.g. as available by Mitotoyo, Japan) or by a capacitance measure (e.g. as available from SolveTech). Inseparable layers can be measured via microscopy, either using optical or atomic force methods. Many of these off-line methods are cumbersome and slow preventing rapid feedback to allow rapid process adjustment and tuning of the layer shape profile.

In some embodiments, it can be useful to measure the layer shape profile and/or distribution on-line and continuously. One particularly useful non-contact thickness measurement system uses a THz range optical line-of-sight technique such as described in FIGS. 2A-2B above. In some embodiments, making layer shape profile or distribution measurements using a THz sensor should have physical layer thicknesses greater than about 10 microns, in some embodiments the physical layer thicknesses should be greater than about 25 microns, in some embodiments the physical layer thicknesses should be greater than about 50 microns, and in some embodiments the physical layer thicknesses should be greater than about 75 microns. The actual minimum physical layer thickness can vary depending on the refractive index of the individual layer materials and the capabilities of the sensing system.

To measure layers with the largest thicknesses in the melt curtain of the bubble 106, in some embodiments the measurement is taken near the die exit 121 (FIG. 1A). To enable this measurement, one method is to lift the air cooling ring 115 sufficiently above the face of the die exit 121 to allow line-of-sight interaction between the THz measurement system 110 and the blowing melt curtain of the bubble 106. Multi-point measurement can be achieved either by mounting THz measurement systems at specific representative locations coordinated with the control devices 103 within the extruder 104 and the feedblock and die 102, or by mounting the THz measurement system on a moving assembly such as the rail 114 that allows circumferential scanning Regardless of the details of the multi-point measurement system 110, the data received from the system can then be reduced to a continuous or discrete circumferential shape distribution.

In another embodiment, the on-line measurement of the shape distribution may be performed in situ of the die 102, e.g. by using a sufficiently transparent window material 123 such as, for example, sapphire glass, fused silica, and the like, around the die in a final section of the annular flow channel. In some cases, this configuration will provide additional advantages to the analysis as it gives the circumferential thickness distributions of individual melt streams flowing in a known gap, which can be, for instance, utilized in achieving active control by changing the concentricity of the inner and outer radii of the die through adjustment of die bolts. Another advantage of this configuration is that the incidence of the THz beam on the layered polymeric streams is automatically ensured to be normal to the plane of the melt streams.

The shape distribution can be used as the objective function in an optimization scheme. In some embodiments, the goal of the scheme is to minimize variations in this objective function. More generally, the minimization of variations from a chosen circumferential pattern of this objective function can be chosen. For example, a film construction including downweb stripes in a periodically repeating manner may alter the objective function for certain layers. The optimization scheme furthermore includes a feedback to a layer control system mechanism 103 (FIG. 1A) that can alter the circumferential distribution of mass flow of at least one material layer in the co-extruded multi-layer flowing construction prior to exit from the extrusion die outlet into the blown film melt curtain. In a further embodiment, the layer shape distribution function can be targeted to match a prescribed circumferential function (with a circumferential average of unity), rather than a constant flat value (of unity). The conformance to this function can then be determined, e.g. by the standard deviation among the measured points. One example of the utility of this further embodiment considers an additional stretching process downstream of the nip rollers. A significant stretching of the film by a length orientation process, e.g. by the stretching of the post-blown film over rolls of increasing speed downstream, may require a prescribed, non-constant targeted shape to achieve a uniformly flat film after stretching.

In some embodiments, the control of the layer shape profiles will also impact the control of the overall thickness of the films. In some cases, it may be sufficient to control the uniformity of the individual layer shapes to control the uniformity of the overall film thickness. In other cases, it may be desirable to combine the control of layer shapes with the separate control of the total thickness of the film around the circumference. In this regard, in some cases, post-die exit control of the blowing and stretching of the bubble may be advantageous, e.g. by differential control of the air temperature circumferentially around the air cooling ring 115 (FIG. 1A).

It should be noted that in some applications, the absolute level of thickness of a given layer in a blown film multilayer may be desired. With careful calibration, this too may be achieved in accordance with the methods and apparatus of the present disclosure.

It should be noted that in another embodiment the methods and apparatus of the present disclosure could also be extended to other film flow configurations, e.g. a flat-film die cast into a final flat film wherein an on-line cross-web THz measurement would functionally replace the on-line circumferential measurement.

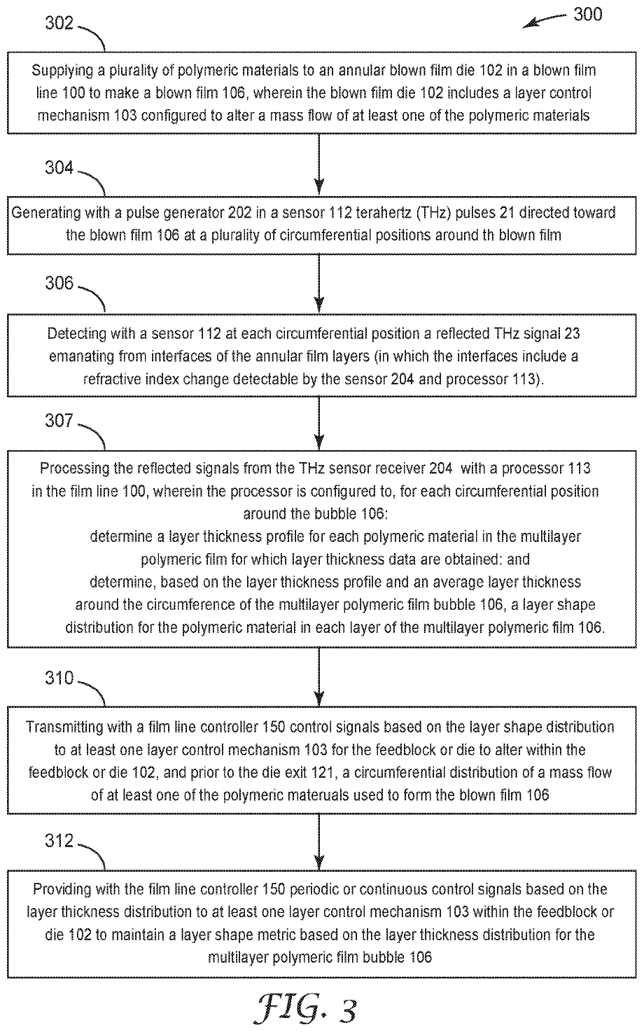

FIG. 3 illustrates an example of an embodiment of a method 300, which is not intended to be limiting, for determining the layer thickness distribution of a multilayered polymeric film made on a blown film line 100 such as shown in FIGS. 1A-1B and 2A-2B discussed above.

In step 302, an extruder 104 supplies a plurality of polymeric materials to an annular blown film die 102 in the blown film line 100 to make a blown film 106, and a layer control mechanism 103 within the extruder 104 or the die 102 is configured to alter a mass flow of at least one of the extruded liquid polymeric materials supplied to the die 102 (FIG. 1A).

In step 304, a sensor 112 in the film line 100 of FIGS. 1A-1B includes a pulse generator 202 that generates THz pulses 21 (FIG. 2A). The pulse generator 202 emits the THz pulses 21 at a plurality of circumferential positions around the blown film bubble 106 toward the targeted multilayered material in the bubble 106 to be measured (FIGS. 2A-2B).

In step 306, a reflected THz signal 23 is generated at each circumferential position at interfaces between annular film layers in which the change in refractive index across the interfaces produces a reflection that is detectable by the sensor system, and the reflected THz signal 23 is detected by a sensor 204 (FIGS. 2A-2B) and sensor system 110 (FIG. 1A).

In step 308, a processor 113 in a computing device 160 interfaced with the film line 100 processes the reflected signals from the THz sensor 204. The processor is configured to, for each circumferential position around the bubble 106:

determine a layer thickness profile for each polymeric material in the multilayer polymeric film for which layer thickness data are obtained; and

determine, based on the layer thickness profile and an average layer thickness profile around the circumference of the multilayer polymeric film bubble 106, a layer shape distribution for the polymeric material in each layer of the multilayer polymeric film 106.

In step 310, a film line controller 150 receives input from the processor 113 (FIG. 1A), and the controller 150 generates and transmits at least one control signal based on the layer shape distribution to at least one layer control mechanism 103 for the feedblock or die 102. The control signal causes at least one layer control mechanism 103 to alter within the feedblock or die 102, and prior to the die exit 121, a circumferential distribution of a mass flow of at least one of the polymeric materials used to form the blown film 106.

In step 312, the film line controller 150 provides periodic or continuous control signals based on the layer thickness distribution to at least one layer control mechanism 103 within the feedblock or die 102 to maintain a layer shape metric based on the layer thickness distribution for the multilayer polymeric film 106. As noted above, in some embodiments, the film line controller may further utilize date from other sources such as, for example, IR cameras.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

The devices of the present disclosure will now be further described in the following non-limiting examples.

### EXAMPLES

In the following examples, a particular multilayer construction was chosen that allowed for the direct physical separation of the film into its component layers, so that direct comparison of physical thickness measurements through standard techniques such as electric capacitance measurement of caliper (e.g. using a PR2000 Precision Profiler available from SolveTech, Inc., 1711 Philadelphia Pike, Wilmington, Del. 19809, USA) could be made with the measurements using a THz sensor. The SolveTech PR 2000 gauge measured the dielectric properties of the material using a calibrated capacitance method, which allowed computation of the thickness of a material measured by the gauge.

The selected construction included an inner and outer polylactic acid miscible mixture (hereafter referred to as the PLA Blend) with an inner polyethylene core layer. The three layers were thus formed in a co-extrusion process involving seven different extruders, feedstreams and combination of these seven polymeric material streams in the blown film feedblock/die. The first two extruders, each fed with the PLA Blend mixture, formed the final merged inner PLA layer in contact with the bubble blowing gas. The middle three extruders were feed with the LDPE to form the final merged core layer. The outer two extruders, each fed with the PLA Blend mixture, formed the final merged outer PLA layer in contact with the air ring cooling air. Thus, the inner PLA layer, the core LDPE layer and the outer PLA layer comprised three measurable layers formed from seven initial polymeric material streams.

In this series of examples, the PLA Blend mixture was separately mixed using a twin screw extruder and pelletized prior to extrusion in the blown film process. In particular, the PLA blend mixture included approximately 74% of a polylactic acid available from NatureWorks, Minnetonka, Minn., under the trade designation Ingeo 4032D; 16% of a polyvinyl acetate available under the trade designation Vinnapas UW2FS from WackerChemie, Ann Arbor, Mich.; and 10 wt % of an oligomer ester available under the trade designation Hallgreen R-8010 from Hallstar, Chicago, Ill. The multilayer construction core layer included polyethylene, LDPE, available under the trade designation Dow 611A from DowDuPont, Midland, Mich.

The co-extrusion casting, drawing and blowing were performed in a blown film process using a small-scale line, such as those available from Labtek, Grand Rapids, Mich. The particular die/feedblock was of the so-called pancake design for this particular set of examples.

### Example 1—Determination of the Layer Shape Distribution

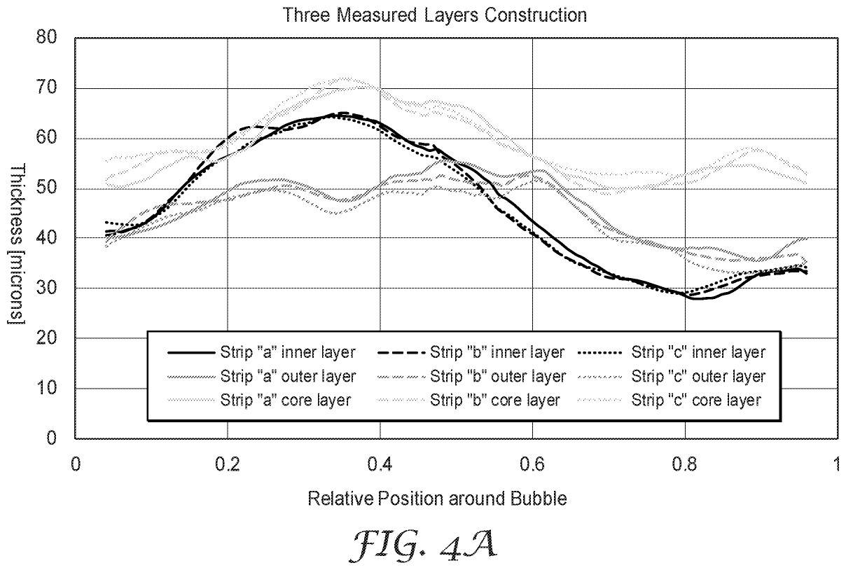

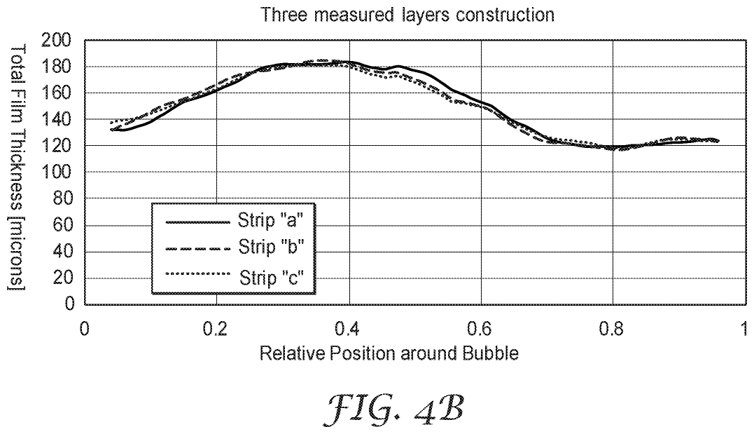

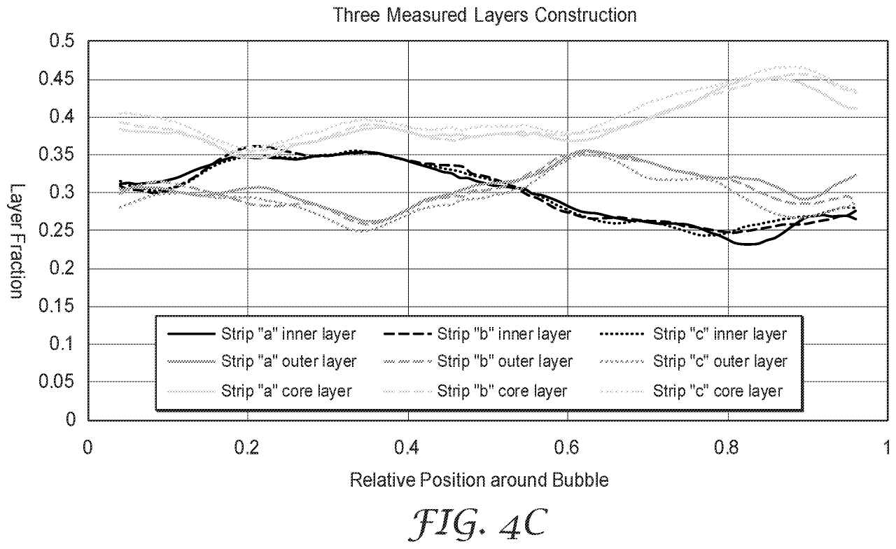

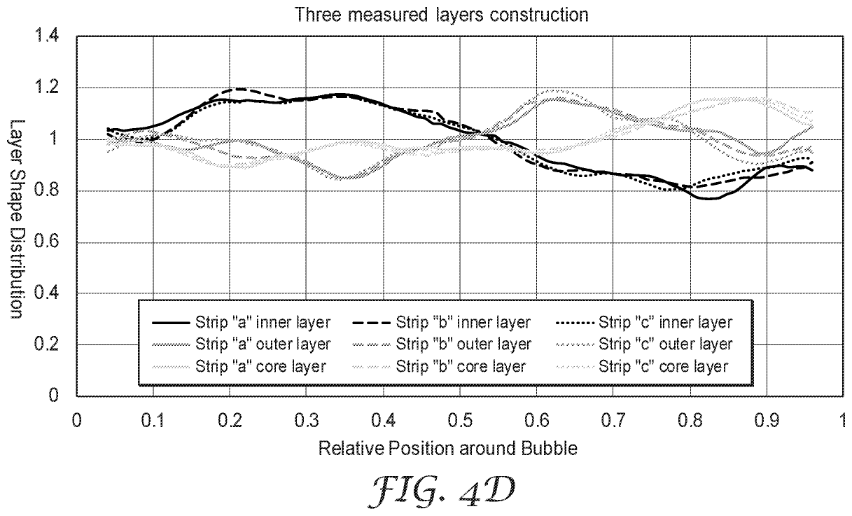

Films were made as generally described above. Three separate downstream circumferential strips (e.g. strips a, b, c) were cut from the lay-flat film. The strips were cut at three downstream positions along the final wound roll representing a time separation in the process of about 20 and 50 seconds between the first and second strip and the first and third strip, respectively. Each strip was cut at the so-called “east” position to re-open the tube into a single flat film. The film was then furthermore peeled apart into its three final constituent layers, the inner (PLA Blend), core (LDPE) and outer (PLA Blend) layers. At all junctures during the procedures, careful labeling was made to ensure proper identification and circumferential alignment of the variation layers. Each layer of each strip was then individually measured. The layer shape distribution was then constructed in accordance with the schematic method presented in FIG. 4.

In FIG. 4, the circumferential angular coordinate is normalized to unity (e.g. instead of 2π radians). The zero position is at one cut edge of the original lay-flat film. The normalized coordinate moves circumferentially around the bubble so that the second folded edge of the lay-flat film is at 0.5, and the film returns to the initial cut fold (i.e. so-called “East” position) at 1.0. The fidelity of the measurements is seen by the close alignment of the data among the three different downweb strips measured. In this manner, the data also shows the stability of the process to at least a minute in duration. This suggests the plausible robustness and utility of a scanning method for an on-line measurement of the layer shape distribution.

It is evident that the layer shape distribution method can be applied to any collection of layer thickness data, independent of the type of sensor or sensor location, with one embodiment being an on-line terahertz measurement at or near the die exit.

### Example 2—On-Line Measurement by THz Sensor at Multiple Locations Around Bubble Circumference

In this example, on-line thickness measurements of individual layer thicknesses were made at two different circumferential positions, here referred to as “SW” and “ESE” respectively. It is straight-forward to generalize the method to a measurement on a scanning frame that allows a full measurement of the circumferential layer shape distributions, especially in light of the process stability demonstrated by Example 1.

Five process conditions were studied, labeled 1.1, 1.2, 1.3, 1.4 and 1.5 in Table 1:

TABLE 1

| | | Outer PLA | Core PE | Inner PLA | Total, | | | |
|---|---|---|---|---|---|---|---|---|
| | THz | thickness | Thickness | Thickness | TOF | | | |
| Condition | Location | (microns) | (microns) | (microns) | (microns) | Outer PLA | Core PE | Inner PLA |
| 1.1 | ESE | 520 | 618 | 369 | 1507 | 34.5% | 41.0% | 24.5% |
| 1.1 | SW | 366 | 580 | 446 | 1391 | 26.3% | 41.7% | 32.0% |
| 1.2 | ESE | 516 | 608 | 434 | 1558 | 33.1% | 39.0% | 27.9% |
| 1.2 | SW | 371 | 577 | 450 | 1398 | 26.6% | 41.3% | 32.2% |
| 1.3 | ESE | 499 | 597 | 420 | 1516 | 32.9% | 39.4% | 27.7% |
| 1.3 | SW | 356 | 563 | 443 | 1362 | 26.1% | 41.3% | 32.5% |
| 1.4 | ESE | 499 | 598 | 410 | 1507 | 33.1% | 39.7% | 27.2% |
| 1.4 | SW | 355 | 559 | 426 | 1340 | 26.5% | 41.7% | 31.8% |
| 1.5 | ESE | 511 | 615 | 426 | 1552 | 32.9% | 39.7% | 27.4% |
| 1.5 | SW | 371 | 584 | 449 | 1404 | 26.4% | 41.6% | 32.0% |

### Example 3—Comparison of Direct, Off-Line, Capacitance Measurements on Individual Layers and THz On-Line Measurements

In this example, the THz on-line measurement was validated by comparison to a well-known industrially standard measurements, a calibrated capacitance measurement made on individual layers. The results are shown in Table 2 below.

From a standpoint of Layer Shape Uniformity, the actual thickness of the layers as measured is not significant, but rather only the relative change in its value around the circumference. Nevertheless, in some applications, if may be desirable to also have an on-line measurement of the absolute thickness of individual layers. This example also shows that with careful calibration, this can be achieved.

TABLE 2

| | | Condition | Outer PLA | Core PE | Inner PLA | Total, | Outer PLA | Core PE | Inner PLA |
|---|---|---|---|---|---|---|---|---|---|
| | | (and off- | thickness | Thickness | Thickness | TOF | Fraction | Fraction | Fraction |
| Method | Data treatment | line strip) | (microns) | (microns) | (microns) | (microns) | (%) | (%) | (%) |
| THz SW | on-line | 10-4.1 | 245 | 496 | 330 | 1072 | 22.9% | 46.3% | 30.8% |
| Solvetech | as is off-line | 10-4.1b | 28.4 | 49.4 | 42.9 | 121 | 23.6% | 40.9% | 35.5% |
| Solvetech | as is off-line | 10-4.1c | 23.9 | 48.9 | 39.6 | 112 | 21.2% | 43.5% | 35.3% |
| Solvetech | density adjusted | 10-4.1b | 31.5 | 65.4 | 47.6 | 145 | 21.8% | 45.3% | 32.9% |
| Solvetech | density adjusted | 10-4.1c | 26.5 | 64.8 | 43.9 | 135 | 19.6% | 47.9% | 32.5% |
| Solvetech | density adjusted | average | 29.0 | 65.1 | 45.7 | 140 | 20.7% | 46.6% | 32.7% |
| THz SW | on-line | 10-4.3 | 297 | 509 | 412 | 1217 | 24.4% | 41.8% | 33.8% |
| Solvetech | as is off-line | 10-4.3a | 41.5 | 61.0 | 61.1 | 164 | 25.4% | 37.3% | 37.3% |
| Solvetech | as is off-line | 10-4.3b | 43.2 | 62.0 | 61.8 | 167 | 25.9% | 37.1% | 37.0% |
| Solvetech | density adjusted | 10-4.3a | 46.0 | 80.7 | 67.7 | 194 | 23.7% | 41.5% | 34.8% |
| Solvetech | density adjusted | 10-4.3b | 47.9 | 82.1 | 68.5 | 198 | 24.1% | 41.4% | 34.5% |
| Solvetech | density adjusted | average | 46.9 | 81.4 | 68.1 | 196 | 23.9% | 41.4% | 34.7% |
| THz SW | on-line | 10-4.5 | 312 | 514 | 439 | 1266 | 24.7% | 40.6% | 34.7% |
| Solvetech | as is off-line | 10-4.5a | 45.7 | 64.5 | 64.0 | 174 | 26.2% | 37.0% | 36.7% |
| Solvetech | as is off-line | 10-4.5c | 47.9 | 63.8 | 65.3 | 177 | 27.1% | 36.0% | 36.9% |
| Solvetech | density adjusted | 10-4.5a | 50.7 | 85.4 | 70.9 | 207 | 24.5% | 41.3% | 34.3% |
| Solvetech | density adjusted | 10-4.5c | 53.1 | 84.4 | 72.3 | 210 | 25.3% | 40.2% | 34.5% |
| Solvetech | density adjusted | average | 51.9 | 84.9 | 71.6 | 208 | 24.9% | 40.7% | 34.4% |

In this example, three conditions were studied, 10-4.1, 10-4.3 and 10-4.5. The results shown in Table 2 show that the on-line THz data reveals similar trends to the off-line SolveTech gauge measurement, but that some adjustments were needed for complete calibration. The absolute thickness is a function of the index of refraction of the materials at the measuring THz frequency and temperature. The second obvious difference in the absolute numbers is that the THz measurement was performed prior to the bubble stretching. Thus, the thicknesses are absolutely larger due to the biaxial draw ratio the film experiences during drawing. Nevertheless, the percent composition by layer thickness also varied between the two measurements.

The third correction needed to properly calibrate the methods is relates the temperature dependences of the densities of the various material layers. In particular, the THz measurement was performed on-line with a melt curtain (bubble) flow stream near the extrusion die temperature around 185° C. The off-line SolveTech measurement was performed at laboratory room temperature around 23° C. To properly calibrate the method from a layer thickness fraction basis, this final correction must also be made. Density can be affected by a number of factors, including but not limited to temperature in the melt state and also by crystallization in any of the material layers.

In this example, the LDPE was estimated to densify from about 0.74 g/cc to 0.98 g/cc (for a ratio densification f=1.324) from on-line to off-line conditions. For the PLA Blend, which did not significantly crystallize under the particular drawing conditions of these examples, the material was estimated to densify from about 1.13 to 1.20 g/cc (for a ratio densification of 1.108) from on-line to off-line conditions. These densification estimates were made using values in the literature for LDPE and for analogous variations for amorphous polyethylene terephthalate (1.2 g/cc to 1.33 g/cm), since the temperature data the PLA Blend miscible mixture is available. These densification factors can be further refined by measurements or by data correlations among films as desired. In this manner, on-line measurements of absolute layer thicknesses can also be achieved.

### Example 4—Effect of Differential Heating to Change Circumferential Variation in Layer Thickness

The new coextrusion die/feedblock was used to coextrude seven alternating layers of high- and low-density polyethylene (HDPE and LDPE) of equal amount, i.e., all extruders that feed the layers were operated at the same extrusion rate (see Table 3 for extrusion process conditions). Table 3 shows the final barrel temperature of the extruder and the extruder screw speed—for all the melt streams used in this example. Layers 1, 3, 5, and 7 were made using Dow Elite 5960G1 HDPE; Layers 2, 4, and 6 used DOW 611A LDPE.

TABLE 3

| SAMPLE | 1 | 2 |
|---|---|---|
| Layer 1 | HDPE | HDPE |
| Final barrel temp [° C.] | 188 | 188 |
| Screw Speed [rpm] | 30 | 30 |
| Layer 2 | DOW 611A | DOW 611A |
| Final barrel temp [° C.] | 188 | 188 |
| Screw Speed [rpm] | 30 | 30 |
| Layer 3 | HDPE | HDPE |
| Final barrel temp [° C.] | 188 | 188 |
| Screw Speed [rpm] | 30 | 30 |
| Layer 4 | Dow 611A | Dow 611A |
| Final barrel temp [° C.] | 188 | 188 |
| Screw Speed [rpm] | 30 | 30 |
| Layer 5 | HDPE | HDPE |
| Final barrel temp [° C.] | 188 | 188 |
| Screw Speed [rpm] | 30 | 30 |
| Layer 6 | DOW 611A | DOW 611A |
| Final barrel temp [° C.] | 188 | 188 |
| Screw Speed [rpm] | 30 | 30 |
| Layer 7 | HDPE | HDPE |
| Final barrel temp [° C.] | 188 | 188 |
| Screw Speed [rpm] | 30 | 30 |

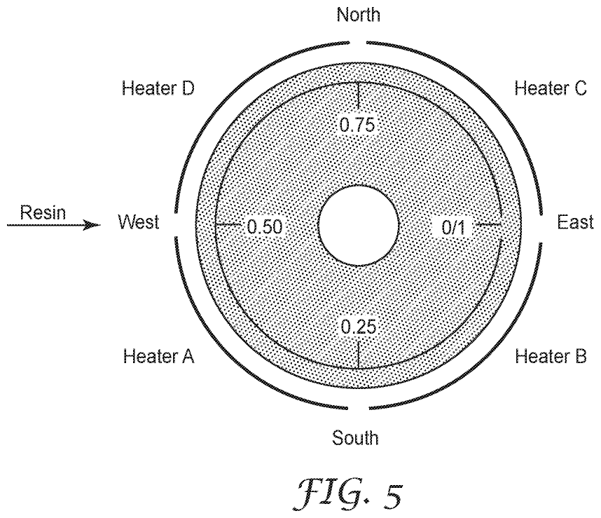

With the objective of demonstrating the utility of localized heat to change the circumferential distribution of a layer, segmented, band heaters that wrap around the part of the die/feedblock that creates this layer (heaters A-D in FIG. 5) were heated in a differential manner by setting different temperature set points for these heaters. Particularly, set points of the two pairs of diametrically opposite heaters were changed between two conditions so that more flow could be promoted to one half of the bubble/film (thus making that portion of the film locally thick) and less flow could be promoted to the other half (thus making that section locally thin) when we moved between the two conditions. Layer 7, which is the outermost layer in the multilayer stack that is introduced by the die/feedblock plate positioned at the top of the stack of the plates and, thus, which is the last layer to join the rest of the layers in the die/feedblock, is used in this example. In the alternating HDPE-LDPE structure chosen for this experiment, Layer 7 is an HDPE layer.

The set points for these conditions are tabulated in Table 4, which shows temperature set points for the segmented band heaters of Layer 7 (see FIG. 5 for the locations of these heaters in the case of Layer 7).

TABLE 4

| | |
|---|---|
| Heater zone | Temperature set point [° C.] |

| for Layer 7 | Sample 1 | Sample 2 |
|---|---|---|
| A | 197 | 193 |
| B | 193 | 197 |
| C | 190 | 193 |
| D | 193 | 190 |

In the experiment, these conditions were identified as Conditions 1 and 2. In Condition 1, zone A was set at 386° F. (197° C.); zone C was set at 374° F. (190° C.); and the two other zones, B and D, were set at 380° F. (193° C.). In Condition 2, these set points were swapped with the other pair of diametrically opposite zones, i.e., zones B and D were set at 386° F. (196° C.) and 374° F. (190° C.), respectively, and zones A and C were set at 380° F. (193° C.).

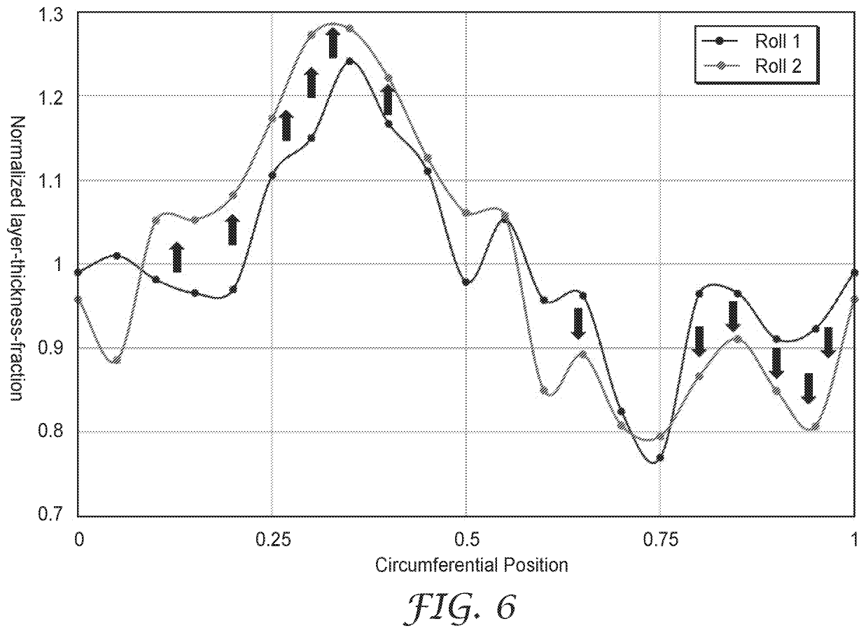

The result of these settings is presented in FIG. 6, which contains a chart showing the crossweb (circumferential) variation in the layer-thickness fraction (normalized with its average value), i.e. the layer shape distribution, of this layer from films made using these settings. The layer-thickness fraction was calculated from thickness of all the layers that were measured using atomic force microscopy.

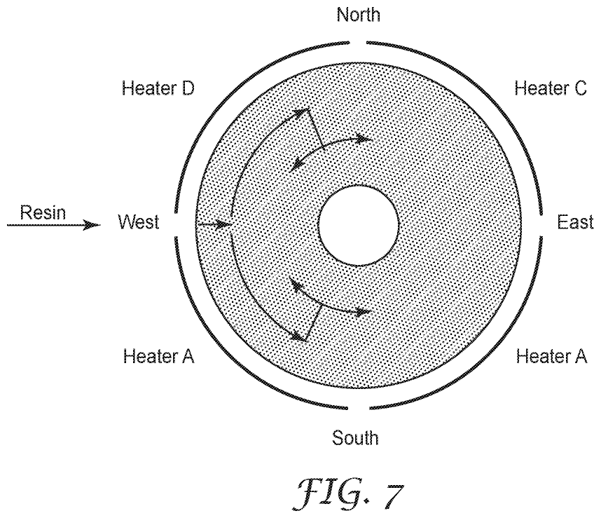

From FIG. 6, it is evident that the circumferential variation in the thickness of a layer can be changed by applying heat in a differential manner, in this case from outside the layer plate that feeds the layer to the multilayer stack. By adding heat to zone B, in addition to keeping zone A at or above temperature set points for zones C and D, that half of the bubble/film was made even thicker in Condition 2 compared to Condition 1 (please refer FIG. 5 for a schematic of the locations on the lay-flat film that is overlaid on the locations of the heater zones). Since mass is conserved, the other half of the bubble saw a local reduction in mass when we moved from Condition 1 to 2. This contrast in thickness between the sides of the bubble was further enhanced by cooling zone D in Condition 2 compared to Condition 1. Localized cooling in this part of the layer plate results in increased restriction of flow into this area by the local increase in viscosity of the resin (due to the reduction in temperature) in the primary feeding channel for this half of the layer (see FIG. 7 for the location of the feeding channels within the layer plate with respect to the location of segmented band heaters around the plate). This increased flow restriction reduces the flow into this half of the spiral and, thus, reduces the thickness of the layer on this half of the bubble/film.

### Additional Embodiments

A. A blown film line, comprising:

a feedblock configured to supply at least two different polymeric material streams to an annular blown film die to form a plurality of at least two layers comprising different polymeric materials;

at least one terahertz (THz) sensor that emits a THz signal toward selected circumferential positions around the film bubble and receives a plurality of reflected signals at each circumferential position, wherein each reflected signal in the plurality of reflected signals is generated at an interface between annular layers of the at least two different polymeric materials in the multilayered polymeric film bubble, wherein the interface comprises a change in refractive index detectable by the THz sensor, and wherein the annular layers have a thickness of greater than about 25 microns; and

a film line controller that receives the plurality of reflected signals from the THz sensor, wherein the film line controller comprises a processor configured to, for each circumferential position:
determine a layer thickness profile for each polymeric material in the multilayer polymeric film bubble for which layer thickness data are obtained; and
determine, based on the layer thickness profile and an average layer thickness profile around the circumference of the multilayer polymeric film bubble, a layer thickness distribution of the polymeric material in each layer of the multilayer polymeric film bubble; and
   wherein the film line controller provides control signals based on the layer thickness distribution to at least one layer control mechanism within the feedblock to maintain a layer shape metric based on the layer thickness distribution for the multilayer polymeric film bubble.
   B. The blown film line of Embodiment A, wherein the film line controller changes a mass flow of at least one of the polymeric materials within the feedblock and prior to exit from the blown film die.
   C. The blown film line of Embodiment A or B, wherein the film line controller provides continuous feedback to the at least one layer control mechanism based on the layer shape metric.
   D. The blown film line of any of Embodiments A to C, wherein the layer shape metric is a uniformity metric.
   E. The blown film line of any of Embodiments A to D, wherein the THz sensor is positioned above a frost line.
   F. The blown film line of any of Embodiments A to E, wherein the THz sensor is positioned between a die exit and a frost line.
   G. The blown film line of any of Embodiments A to F, further comprising a cooling ring downstream from the annular die, wherein the THz sensor is positioned between the cooling ring and a frost line.
   H. The blown film line of any of Embodiments A to G, further comprising a cooling ring downstream from the annular die, wherein the THz sensor is positioned between a die exit and the cooling ring.
   I. The blown film line of any of Embodiments A to H, further comprising a cooling ring downstream from the annular die, wherein the cooling ring comprises multiple cooling zones, and wherein the THz sensor is disposed between the multiple cooling zones.
   J. The blown film line of any of Embodiments A to I, wherein the THz sensor is positioned away from the film bubble with a standoff distance D from about 25 mm to about 150 mm. K. The blown film line of any of Embodiments A to J, wherein the layer shape control mechanism comprises a heating zone within the feedblock.
   L. The blown film line of Embodiment K, wherein the heating zones control a temperature of a feeder tube for a polymeric material stream around the annular flow circumference of the blown film die.
   M. The blown film line of any of Embodiments K to L, wherein the layer control mechanism comprises a flow resistance control device in the feedblock.
   N. The blown film line of any of Embodiment M, wherein the flow resistance control device is chosen from valves, vanes, die bolts, and combinations thereof.
   O. The blown film line of any of Embodiments A to N, wherein the annular layers have a thickness of greater than about 10 microns.
   P. The blown film line of any of Embodiments A to O, wherein the THz sensor is on an angularly adjustable mount, and wherein the THz sensor emits a signal directed toward a sensing point on the film bubble at a substantially normal incidence.
   Q. The blown film line of any of Embodiments A to P, wherein the processor is configured to, for each circumferential position:
determine a layer thickness fraction for each polymeric material in the multilayer polymeric film for which layer thickness data are obtained; and

determine, based on the layer thickness fraction and an average layer thickness fraction around the circumference of the multilayer polymeric film bubble, a layer shape distribution for the polymeric material in each layer of the multilayer polymeric film.

R. A sensing system for online measurement of a multilayered blown polymeric film comprising a plurality of polymeric materials, wherein at least two of the polymeric materials have differing refractive indices at a terahertz (THz) frequency, the sensing system comprising:

a terahertz (THz) sensor positioned adjacent to a film bubble extruded from an annular blown film die, wherein the blown film bubble comprises annular layers of at least two polymeric materials, wherein the annular layers have a thickness of greater than about 25 microns;

a sensor support configured to guide the THz sensor around the circumference of the film bubble, wherein the THz sensor emits a THz signal toward selected circumferential positions around the film bubble and receives a plurality of reflected signals at each circumferential position, wherein each reflected signal in the plurality of reflected signals is generated at an interface between the annular layers of polymeric materials in the multilayered polymeric film, the interface comprising a refractive index change detectable at a THz frequency; and

a processor that processes the reflected signals from the THz sensor, wherein the processor is configured to generate a layer thickness distribution at each circumferential position of the polymeric material in each annular layer of the multilayer polymeric film.

S. The system of Embodiment R, wherein the layer thickness distribution is generated by determining a layer thickness profile for each measurable layer in the multilayer polymeric film at each circumferential position; and determining a layer thickness distribution at each circumferential position of the polymeric material in each annular layer of the multilayer polymeric film based on the layer thickness fraction and an average layer thickness fraction.
T. The system of Embodiment S, wherein the layer thickness distribution is generated by determining a layer thickness fraction for each measurable layer in the multilayer polymeric film at each circumferential position.

Various embodiments of the invention have been described. These and other embodiments are within the scope of the following claims.

1. A sensing system for measurement of a multilayered blown polymeric film, the sensing system comprising:
a feedblock configured to supply a plurality of polymeric material streams to an annular blown film die to form a plurality of layers comprising different polymeric materials;
a sensing system positioned adjacent to a film bubble extruded from the blown film die, wherein the blown film bubble comprises annular layers of at least two different polymeric materials, wherein the sensing system emits a signal toward selected circumferential positions around the film bubble and receives a plurality of reflected signals at each circumferential position, wherein each reflected signal in the plurality of reflected signals is generated at an interface between annular layers, and wherein the interface comprises a refractive index change detectable by the sensing system; and
a processor that processes the reflected signals from the sensing system, wherein the processor is configured to, for each circumferential position:
determine a layer thickness profile for each polymeric material in the multilayer polymeric film for which layer thickness data are obtained; and
determine, based on the layer thickness profile and an average layer thickness profile around the circumference of the multilayer polymeric film bubble, a layer shape distribution for the polymeric material in each layer of the multilayer polymeric film.

2. The system of claim 1, further comprising a film line controller that receives input from the processor, wherein the controller provides a control signal based on the layer shape distribution to at least one layer control mechanism for the feedblock, and wherein the layer control mechanism is configured to alter within the feedblock and prior to exit from the blown film die a circumferential distribution of a mass flow of at least one of the polymeric material streams.

3. The system of claim 2, wherein the film line controller provides continuous feedback to the at least one layer control mechanism based on a layer shape metric derived from the layer shape distribution.

4. The system of claim 2, wherein the layer control mechanism comprises at least one heating zone, wherein at least one of the heating zones controls a temperature of a feeder tube for a polymeric material stream around the annular flow circumference of the blown film die.

5. The system of claim 2, wherein the layer control mechanism comprises at least one heater.

6. The system of claim 2, wherein the layer control mechanism comprises a flow resistance control device chosen from valves, vanes, die bolts, and combinations thereof.

7. The system of claim 1, wherein the annular layers have a thickness of greater than about 10 microns.

8. The system of claim 1, wherein the processor is further configured to determine a total thickness profile of all the layers in the multilayered polymeric film.

9. The system of claim 1, wherein the sensor system comprises at least one sensor mounted on a sensor support comprising an angularly adjustable mount such that the sensor emits a signal directed toward a sensing point on the film bubble at a substantially normal incidence.

10. The system of claim 1, wherein the sensing system comprises at least one terahertz (THz) sensor.

11. The system of claim 1, wherein processor is configured to, for each circumferential position:
determine a layer thickness fraction for each polymeric material in the multilayer polymeric film for which layer thickness data are obtained; and
determine, based on the layer thickness fraction and an average layer thickness fraction around the circumference of the multilayer polymeric film bubble, a layer shape distribution for the polymeric material in each layer of the multilayer polymeric film.

12. A method for online measurement of a blown multilayer polymeric film, the method comprising:
positioning a terahertz (THz) sensor adjacent to a multilayer polymeric film bubble extruded from an annular blown film die, wherein the multilayer polymeric film bubble comprises a plurality of annular layers of at least two different polymeric materials, wherein at least two of the different polymeric materials have differing refractive indices, and wherein at least two of the annular layers comprising different polymeric materials have a thickness of greater than about 10 microns;
guiding the THz sensor around a circumference of the film bubble,
emitting a THz signal from the THz sensor toward selected circumferential positions around the film bubble, wherein the THz sensor receives a plurality of reflected signals at each circumferential position, and wherein each reflected signal in the plurality of reflected signals is generated at an interface between the annular layers of the polymeric material in the multilayered polymeric film bubble, wherein the interface comprises a refractive index change detectable at a THz frequency; and
providing the reflected signals from THz sensor to a processor configured to, for each circumferential position around the film bubble:
determine a layer thickness profile for each measurable layer in the multilayer polymeric film bubble for which a layer thickness is obtained; and
determine, based on the layer thickness profile and an average layer thickness profile around the circumference of the multilayer polymeric film bubble, a layer thickness distribution of the polymeric material in each annular layer of the multilayer polymeric film bubble; and
generating a control signal based on the layer thickness distribution to control at least one layer control system within a feedblock supplying polymeric materials to the blown film die, wherein the layer control system maintains a predetermined layer shape profile of the multilayer polymeric film bubble.

13. The method of claim 12, wherein the layer control system changes a mass flow of at least one of the polymeric materials within the feedblock and prior to exit from the blown film die.

14. The method of claim 12, wherein the processor provides continuous feedback to the layer control system based on a layer shape metric derived from the layer thickness distribution.

15. The method of claim 12, wherein processor is configured to, for each circumferential position:
determine a layer thickness fraction for each polymeric material in the multilayer polymeric film for which layer thickness data are obtained; and
determine, based on the layer thickness fraction and an average layer thickness fraction around the circumference of the multilayer polymeric film bubble, a layer shape distribution for the polymeric material in each layer of the multilayer polymeric film.
